(19) United States
(12) Patent Application Publication
(10) Pub. No.: US 2024/0179810 A1
(43) Pub. Date: May 30, 2024

(54) DOMESTIC APPLIANCE HAVING A MICROWAVE FUNCTION AND METHOD FOR OPERATING SAID APPLIANCE

(71) Applicant: Miele & Cie. KG, Guetersloh (DE)

(72) Inventors: Olaf BLOEMKER, Warendorf (DE); Eckhard POEHLER, Versmold (DE)

(21) Appl. No.: 18/518,474

(22) Filed: Nov. 23, 2023

(30) Foreign Application Priority Data
Nov. 29, 2022 (DE) 10 2022 131 468.5

(51) Int. Cl. H05B 6/64

(52) U.S. Cl. CPC H05B 6/6447

(57) ABSTRACT

A domestic appliance for heating a foodstuff includes: an interior space for receiving the foodstuff; a magnetron for generating microwave radiation; a switched-mode power supply for operating the magnetron; and a control unit for controlling the switched-mode power supply. The domestic appliance detects and evaluates a pulse width of an anode current of the magnetron.

### CROSS-REFERENCE TO PRIOR APPLICATION

Priority is claimed to German Patent Application No. DE 10 2022 131 468.5, filed on Nov. 29, 2022, the entire disclosure of which is hereby incorporated by reference herein.

### FIELD

The invention relates to a domestic appliance for heating a foodstuff, having an interior space for receiving the foodstuff and a magnetron for generating microwave radiation. The invention also relates to a method for operating such a domestic appliance.

### BACKGROUND

From the prior art, domestic appliances, in particular cooking appliances having a microwave function, are known, for example microwaves or ovens having a microwave function. In such domestic appliances, the microwave radiation is usually generated by a magnetron, approximately at 2.4 GHz, and is released into the interior space where it heats and/or cooks liquid-containing foods. In this case, liquid contained in the foodstuff is set in motion by the microwave radiation so that the energy from the microwave radiation is converted into heat and the food is heated. However, if only a relatively small amount of liquid-containing medium, or no liquid-containing medium, is present in the interior space, the majority of the microwave radiation, or even all the microwave radiation, is reflected back to the magnetron. There is then the risk of the magnetron being heated and damaged.

It is known to use load sensors for detecting low or non-existent loads, for example for detecting high proportions of microwave radiation reflected out of the interior space or an increase in temperature of the magnetron. However, it is a disadvantage that it is expensive to provide such sensors in a domestic appliance, and the sensors are also usually susceptible to faults.

### SUMMARY

In an embodiment, the present invention provides a domestic appliance for heating a foodstuff, comprising: an interior space configured to receive the foodstuff; a magnetron configured to generate microwave radiation; a switched-mode power supply configured to operate the magnetron; and a control unit configured to control the switched-mode power supply, wherein the domestic appliance is configured to detect and evaluate a pulse width of an anode current of the magnetron.

### BRIEF DESCRIPTION OF THE DRAWINGS

Subject matter of the present disclosure will be described in even greater detail below based on the exemplary figures. All features described and/or illustrated herein can be used alone or combined in different combinations. The features and advantages of various embodiments will become apparent by reading the following detailed description with reference to the attached drawings, which illustrate the following:

FIG. 1 is a schematic view of a kitchen unit having a domestic appliance arranged therein according to the first aspect of the invention, in one embodiment;

FIG. 2 is a schematic view of the components of the domestic appliance according to FIG. 1 and their cooperation; and

FIG. 3 is a graph showing values derived from detected pulse widths for different load states of a domestic appliance according to FIG. 1.

### DETAILED DESCRIPTION

In an embodiment, the present invention provides a domestic appliance in which damage to the domestic appliance, in particular the magnetron, is avoided in a simple and cost-effective manner.

In an embodiment, the pulse width of the anode current, in particular the starting pulse width of the anode current, of the magnetron is detected. The load size in the cooking chamber is derived from this pulse width. If no load is present in the cooking chamber (No Load), the starting pulse width is the greatest.

One aspect is that at least the first switching edge of the anode current signal, in particular the starting pulse widths of the first 2 to 9 switching edges of the anode current signal, with the starting pulse width. Wherein, in one embodiment, an average value is formed during the evaluation of a plurality of switching edges. Alternatively, an extreme individual value, in particular the greatest individual value, for the switching edges taken into account can be used for evaluation purposes.

According to a first aspect of the invention, a domestic appliance is provided for heating a foodstuff, having an interior space for receiving the foodstuff, a magnetron for generating microwave radiation, a switched-mode power supply for operating the magnetron and a control unit for controlling the switched-mode power supply, the domestic appliance being designed to detect and evaluate the pulse width of the anode current of the magnetron.

In particular, the starting pulse width of the periodically recurring anode current signal is used. The starting pulse width comprises the first microsecond up to 100 microseconds of the anode current pulse.

The domestic appliance is designed, for example, as a microwave or oven having a microwave function, the interior space being designed as a cavity that is closable by means of a door. For example, an entry opening, behind which the magnetron is arranged, is then provided in the interior space so that microwave radiation generated by the magnetron is coupled into the interior space through the entry opening. The microwave radiation forms a standing wave in the interior space and acts on a foodstuff, arranged in the interior space, in order to heat it. In this case, the microwave radiation in particular has a frequency of 2.4 GHZ and thus lies in the ISM band.

A magnetron is a vacuum drift tube for generating electromagnetic waves in the microwave range and consists, for example, of a roll-shaped hot cathode (oxide or supply cathode) in the center of the vacuum tube, which is enclosed by a solid, cylindrical anode made of copper, the anode having slots arranged approximately in the shape of a beam and running in parallel with the cathode. A switched-mode power supply is an electronic assembly which converts an unstabilized input voltage into a constant output voltage, and is in particular designed as a high-voltage switched-mode power supply.

Achieving the object with the above-described domestic appliance therefore now includes the teaching that the pulse width of the anode current is detected and evaluated during operation of the magnetron. The invention has recognized that the load quantity of the interior space is quantified on the basis of the pulse width, and in particular an empty interior space can be detected. In this case, there is an inversely proportional relationship between the pulse width and the load. A high pulse width thus corresponds to a low load, and vice versa. This relationship is based on the fact that the current applied to the anode by the switched-mode power supply has a small pulse width per se, the anode current, however, being superimposed by reflected microwave radiation, and the pulse width being increased thereby. The pulse width is in this respect a measure of the microwave radiation reflected from the interior space to the magnetron or the amount of energy arriving at the magnetron. If a low load state or empty interior space is detected, corresponding measures for preventing damage to the magnetron can then be proposed or carried out by the domestic appliance. Advantageously, in this case the detection of the low load state or the empty interior space does not require any means provided separately for this purpose, such as load sensors, and therefore the domestic appliance has a simple and cost-effective design.

In a preferred embodiment, the switched-mode power supply is set up to detect the pulse width of the anode current of the magnetron. The anode current is directly applied to the switched-mode power supply so that detection by the switched-mode power supply can be particularly simple. Further preferably, the switched-mode power supply is set up to output the pulse width for the anode current of the magnetron as a value. In this case, the value forms the pulse width, for example numerically, and is in this respect directly proportional to the pulse width. For example, the switched-mode power supply outputs the pulse width as a digital value. Such a value can be received by means correspondingly designed for evaluating the pulse width, and can be evaluated particularly easily. In particular, a digital value can be evaluated particularly efficiently by data processing means and corresponding algorithms.

Preferably, the control unit is designed to evaluate the pulse width of the anode current of the magnetron. The control unit usually in any case comprises means which are suitable for data processing, so that evaluation by the control unit can be particularly easy and not require additional means. Insofar as the switched-mode power supply unit is in any case connected to the control unit for the exchange of signals, for example, the value output by the switched-mode power supply can be received by the control unit for evaluation purposes.

According to a second aspect of the invention, the object is also achieved by a method for operating a domestic appliance as described above, the pulse width of the anode current of the magnetron being detected and evaluated. In this case, a deviation between the pulse width and a pulse width applied to the magnetron by the switched-mode power supply is evaluated so that a load state of the domestic appliance or of the interior space comprising a liquid-containing medium can be detected on the basis of the evaluation of the detected pulse width. In this respect, the method enables the detection of a low or empty load state and an associated risk of damage to the magnetron without means to be additionally provided in the domestic appliance. If such a load state or a risk of damage is detected, corresponding measures can then be proposed or taken by the domestic appliance, for example by the control unit. In this respect, the method according to the second aspect of the invention accordingly has the advantages described above with respect to the first aspect of the invention.

In one embodiment of the method, above a first limit value for the detected pulse width, a notification about a low load state is output to a person using the domestic appliance. for example via a display element of the domestic appliance or via a data connection to a terminal of the person. The first limit value is selected according to a load that is assessed as being “low”, for example. The operating person is then able to detect the low load and the associated risk of damage to the domestic appliance, and can, for example, reduce the power of the magnetron or terminate the heating process after a relatively short time in order to prevent damage to the domestic appliance.

In a further embodiment, the power of the magnetron is reduced above a second limit value for the detected pulse width. The second limit value is selected according to a load that is assessed as being “low” or “very low”, for example. By reducing the power, damage to the magnetron is advantageously reduced/prevented.

In yet another embodiment, the operation of the magnetron is set above a third limit value for the detected pulse width. The third limit value is selected according to a load that is assessed as being “very low” or “empty”, for example. Setting the operating mode of the magnetron advantageously reduces/prevents damage to the magnetron. In one design of this embodiment, after the operation of the magnetron has been set, the magnetron is blocked from operating again in order to prevent renewed operation with the present load. For example, blocking process is canceled by opening and/or re-closing a door of the domestic appliance, which is inevitably accompanied by a change in the load state.

If elements are designated by means of a number, i.e., for example, “first element”, “second element” and “third element”, this number is provided purely for differentiation within the drawing and does not represent any dependence of the elements on one another or a mandatory sequence of the elements. This means in particular that, for example, a device or a method does not have to have a “first element” in order to be able to have a “second element”. The device or the method can also have a “first element” and a “third element”, but without necessarily having a “second element”. A plurality of units of an element having a single number can also be provided, i.e., for example, a plurality of “first elements”. In particular, a first limit value can be greater than, smaller than or equal to a second or third limit value.

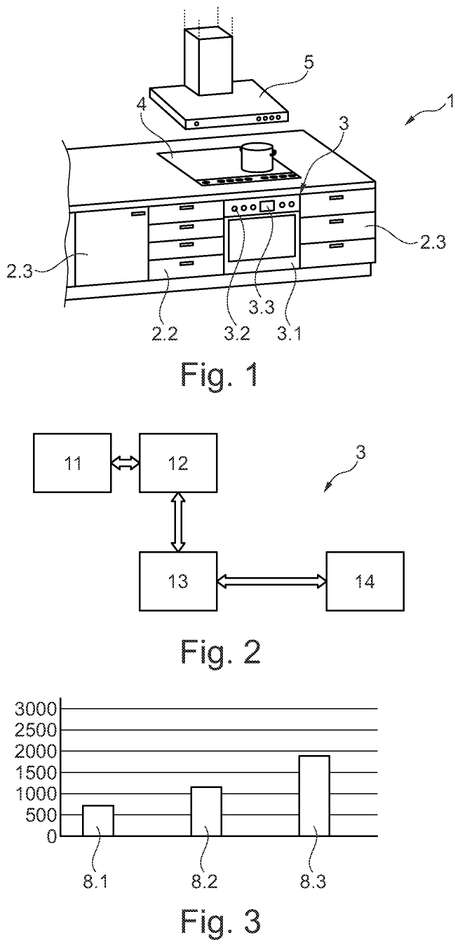

FIG. 1 shows a kitchen unit 1 comprising a plurality of kitchen cabinets 2.1. 2.2, 2.3, a domestic appliance 3 designed as an oven, a cooker 4 and an extractor hood 5 arranged above the cooker 4. The domestic appliance 3 has an interior space 11 that is concealed by a door 3.1, a plurality of operating elements 3.2 and a display element 3.3, and also has a microwave function in addition to at least one baking function. For example, notifications can be output to a person using the domestic appliance 3 via the display element 3.2. The domestic appliance 3 can furthermore also have further functions such as a steam cooking function or a pyrolysis function.

FIG. 2 is a highly simplified illustration of components of the domestic appliance 3, namely the interior space 11 and a magnetron 12 interacting with the interior space 11. In this case, the magnetron 12 is arranged, for example, behind an entry opening of the interior space 11 so that microwave radiation generated by the magnetron 12 can radiate through the entry opening and into the interior space 11. The microwave radiation can then also reach the magnetron 12 from the interior space 11, as shown by a double-headed arrow. Furthermore, the domestic appliance 3 has a switched-mode power supply 13 which interacts with the magnetron 12 and outputs an output voltage and thus operates the magnetron 12 in order to generate microwave radiation. In this case, the switched-mode power supply 13 can detect electrical variables applied to the magnetron 12 so that two-sided interaction is provided, as shown by the double-headed arrow. In particular, the switched-mode power supply 13 detects an anode current applied to the magnetron 12 or the pulse width thereof. Furthermore, the domestic appliance 3 has a control unit 14 which is designed to exchange signals and/or data with the switched-mode power supply 13, as shown by a double-headed arrow. In particular, the control unit 14 is designed to receive and evaluate a value output by the switched-mode power supply 13, which represents the pulse width of the anode current. In this case, the evaluation process is directed to detecting a low or empty load state of the interior space 11. for example on the basis of a pulse width/a value above a limit value.

FIG. 3 shows a graph of a value, in nanoseconds, representing the pulse width of the anode current from tests that comprise a test arrangement and a plurality of loads in the interior space 11. In the test arrangement, the switched-mode power supply 13 detects the anode current of the magnetron 12 and generates therefrom the digital values shown in FIG. 3 therefrom for each load. The absolute pulse widths of the different loads are dependent on the specific test arrangement (not described in more detail here) but not on their relationship to one another. A first pulse width 8.1 of the anode current of approximately 700 nanoseconds results for a glass bowl positioned in the interior space 11 comprising 1000 ml of water. A second pulse width 8.2 of the anode current of approximately 1100 nanoseconds results for a glass bowl positioned in the interior space 11 comprising 100 ml of water. A third pulse width 8.3 of the anode current of approximately 1900 nanoseconds results for an empty glass bowl positioned in the interior space 11.

While the invention has been illustrated and described in detail in the drawings and foregoing description, such illustration and description are to be considered illustrative or exemplary and not restrictive. It will be understood that changes and modifications may be made by those of ordinary skill within the scope of the following claims. In particular, the present invention covers further embodiments with any combination of features from different embodiments described above and below. Additionally, statements made herein characterizing the invention refer to an embodiment of the invention and not necessarily all embodiments.

The terms used in the claims should be construed to have the broadest reasonable interpretation consistent with the foregoing description. For example, the use of the article “a” or “the” in introducing an element should not be interpreted as being exclusive of a plurality of elements. Likewise, the recitation of “or” should be interpreted as being inclusive, such that the recitation of “A or B” is not exclusive of “A and B,” unless it is clear from the context or the foregoing description that only one of A and B is intended. Further, the recitation of “at least one of A, B and C” should be interpreted as one or more of a group of elements consisting of A, B and C, and should not be interpreted as requiring at least one of each of the listed elements A, B and C, regardless of whether A, B and C are related as categories or otherwise. Moreover, the recitation of “A, B and/or C” or “at least one of A, B or C” should be interpreted as including any singular entity from the listed elements, e.g., A, any subset from the listed elements, e.g., A and B, or the entire list of elements A, B and C.

### LIST OF REFERENCE SIGNS

1 Kitchen unit
2.1 Kitchen cupboard
2.2 Kitchen cupboard
2.3 Kitchen cupboard
3 Domestic appliance (designed as an oven)
3.1 Door of the domestic appliance
3.2 Operating element of the domestic appliance
3.3 Display element of the domestic appliance
4 Cooker
5 Extractor hood
8.1 First pulse width
8.2 Second pulse width
8.3 Third pulse width
11 Interior
12 Magnetron
13 Switched-mode power supply
14 Control unit

1. A domestic appliance for heating a foodstuff, comprising:
an interior space configured to receive the foodstuff;
a magnetron configured to generate microwave radiation;
a switched-mode power supply configured to operate the magnetron; and
a control unit configured to control the switched-mode power supply,
wherein the domestic appliance is configured to detect and evaluate a pulse width of an anode current of the magnetron.

2. The domestic appliance of claim 1, wherein the switched-mode power supply is configured to detect the pulse width of the anode current of the magnetron.

3. The domestic appliance of claim 2, wherein the switched-mode power supply is configured to output the pulse width of the anode current of the magnetron as a value comprising a digital value.

4. The domestic appliance of claim 1, wherein the control unit is configured to evaluate the pulse width of the anode current of the magnetron.

5. The domestic appliance of claim 4, wherein the control unit is configured to receive a value output by the switched-mode power supply.

6. The domestic appliance of claim 1, wherein the domestic appliance comprises a microwave appliance or an oven having a microwave function.

7. A method for operating the domestic appliance of claim 1, comprising:
detecting and evaluating the pulse width of the anode current of the magnetron as a detected pulse width.

8. The method of claim 7, wherein, above a first limit value for the detected pulse width, a notification of a low load state is output to a person using the domestic appliance.

9. The method of claim 8, wherein, above a second limit value for the detected pulse width, a power of the magnetron is reduced.

10. The method of claim 9, wherein, above a third limit value for the detected pulse width, an operating mode of the magnetron is set.

11. The method of claim 10, wherein, after the operating mode of the magnetron has been set, the magnetron is blocked from operating again until a door of the domestic appliance is opened and/or closed again.

12. The method of claim 7, wherein the pulse width comprises a starting pulse width for a periodically recurring anode current signal.

13. The method of claim 12, wherein the starting pulse width comprises a first microsecond up to 100 microseconds of the anode current pulse.
